(19) United States
(12) Patent Application Publication
(10) Pub. No.: US 2026/0149192 A1
(43) Pub. Date: May 28, 2026

(54) DOUBLE SIDED EARTH BOLT WITH ANTI ROTATION SYSTEMS AND METHODS

(71) Applicant: Toyota Motor Engineering & Manufacturing North America, Inc., Plano, TX (US)

(72) Inventor: Markiyan Andruchowycz, Ypsilanti, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/960,576

(22) Filed: Nov. 26, 2024

(51) Int. Cl. H01R 4/30; H01R 4/34

(52) U.S. Cl. CPC H01R 4/34; H01R 4/302; H01R 2201/26

(57) ABSTRACT

Methods, systems, and apparatus for a double-sided earth bolt arrangement include a double-sided bolt including a head portion, a first threaded rod extending from the head portion in a first direction, and a second threaded rod extending from the head portion in a second direction, opposite the first direction. The double-sided bolt is configured to be mounted to a ground structure whereby the first threaded rod is threadingly coupled to the ground structure. The arrangement can further include a first earth terminal configured to be installed around the first threaded rod between the head portion and the ground structure. The arrangement can further include a second earth terminal configured to be installed around the second threaded rod and over the head portion.

### BACKGROUND

### Field

The present disclosure relates to an earth bolt for a vehicle and more particularly to systems and methods for coupling multiple terminals to an earth bolt.

### Description of the Related Art

On a vehicle, for example, it is necessary to appropriately supply power to each of a large number of various electrical components from a power source, such as an alternator (generator) or a battery. In many vehicles, at least one wire harness, which is an assembly of a number of electric wires, is routed on the vehicle, and power is supplied by connecting the main power supply and the electrical components of each part via the wire harness(es). Also, junction blocks are used to distribute power to multiple systems, relay boxes are used to control power supply on/off for each system, and fuse boxes are used to protect each wire and load of the wire harness.

A ground (also referred to as earth) completes an electrical circuit by providing a path for current to flow back to the power source. On a vehicle, for example, the ground typically includes the vehicle frame (and other components grounded to the vehicle frame, such as an engine block or other structural components for example). There are often multiple ground wires or terminals that connect to the vehicle frame with limited vehicle frame access.

Accordingly, it is desirable to provide systems, methods, and techniques for connecting multiple ground wires to a vehicle frame in a safe and space efficient manner.

### SUMMARY

One aspect of the subject matter described in this disclosure may be embodied in a double-sided earth bolt arrangement for a vehicle. The double-sided earth bolt arrangement includes a double-sided bolt including a head portion, a first threaded rod extending from the head portion in a first direction, and a second threaded rod extending from the head portion in a second direction, opposite the first direction. The double-sided bolt is configured to be mounted to a vehicle ground structure whereby the first threaded rod is threadingly coupled to the ground structure. The arrangement further includes a first earth terminal configured to be installed around the first threaded rod between the head portion and the ground structure. The arrangement further includes a second earth terminal configured to be installed around the second threaded rod and over the head portion.

In one aspect, the subject matter may be embodied in a vehicle. The vehicle may have a ground structure including a threaded aperture and a double-sided earth bolt arrangement. The double-sided earth bolt arrangement includes a double-sided bolt including a head portion, a first threaded rod extending from the head portion in a first direction, and a second threaded rod extending from the head portion in a second direction, opposite the first direction. The double-sided bolt is configured to be mounted to the ground structure whereby the first threaded rod is threadingly coupled to the ground structure via the threaded aperture. The double-sided earth bolt arrangement can further include a first earth terminal installed around the first threaded rod between the head portion and the ground structure. The double-sided earth bolt arrangement can further include a second earth terminal installed around the second threaded rod and over the head portion.

These and other aspects may optionally include one or more of the following features.

The first earth terminal can include a first attachment portion whereby the first earth terminal is coupled to the first threaded rod and a first tab extending from the first attachment portion. The first tab can be configured to extend along the first direction to be received by an anti-rotation aperture disposed in the ground structure.

The second earth terminal can include a second attachment portion whereby the second earth terminal is coupled to the second threaded rod and a second tab extending from the second attachment portion. The second tab can be configured to extend along the first direction in an installed position.

The second tab can be configured to engage a side surface of the head portion to prevent rotation of the second earth terminal.

The second tab can be configured to be received by a first anti-rotation aperture disposed in the first earth terminal. The second tab can be configured to be received by a second anti-rotation aperture disposed in the ground structure.

The double-sided earth bolt arrangement can further include an anti-rotation structure configured to be installed around the first threaded rod between the head portion and the ground structure. The anti-rotation structure can be configured to be compressed between the head portion and the ground structure. The anti-rotation structure can include an anti-rotation aperture configured to receive the second tab of the second earth terminal. The anti-rotation aperture can be raised above the ground structure.

The head portion of the double-sided bolt can have a hexagonal geometry. The first threaded rod and the second threaded rod can be in coaxial alignment.

In one aspect, the subject matter may be embodied in a method for grounding electrical wiring. The method can include coupling a double-sided bolt to a ground structure, the double-sided bolt includes a head portion, a first threaded rod extending from the head portion in a first direction, and a second threaded rod extending from the head portion in a second direction, opposite the first direction. Coupling the double-sided bolt to the ground structure can include threadingly coupling the first threaded rod to the ground structure. The method can include coupling a first earth terminal around the first threaded rod between the head portion and the ground structure. The method can include coupling a second earth terminal around the second threaded rod and over the head portion.

These and other aspects may optionally include one or more of the following features.

The method can further include tightening the double-sided bolt to the ground structure using the head portion. The method can further include, in response to tightening the double-sided bolt, compressing the first earth terminal between the head portion and the ground structure.

The method can further include positioning a first tab of the first earth terminal in a first anti-rotation aperture disposed in the ground structure. The method can further include positioning a second tab of the second earth terminal in a second anti-rotation aperture that is fixed with respect to the ground structure.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 is a schematic side view of a vehicle that is equipped with a double-sided earth bolt, according to various aspects of the invention.

FIG. 2 is a schematic view of a double-sided earth bolt arrangement installed on a ground structure of a vehicle, according to various aspects of the invention.

FIG. 3A is a perspective view of first terminal installed on a double-sided earth bolt, according to various aspects of the invention.

FIG. 3B is a perspective view of second terminal installed on the double-sided earth bolt of FIG. 3A, according to various aspects of the invention.

FIG. 3C is a top view of the double-sided earth bolt arrangement of FIG. 3B, according to various aspects of the invention.

FIGS. 3D and 3E are section views of the double-sided earth bolt arrangement of FIG. 3C, according to various aspects of the invention.

FIG. 4 is a schematic view of a double-sided earth bolt arrangement including an anti-rotation feature for a second terminal (or top terminal), according to various aspects of the invention.

FIG. 5 is a schematic view of a double-sided earth bolt arrangement including an anti-rotation feature for a second terminal (or top terminal), according to various aspects of the invention.

FIG. 6 is a schematic view of a double-sided earth bolt arrangement including an anti-rotation feature for a second terminal (or top terminal), according to various aspects of the invention.

FIG. 7 is a schematic view of various terminals which can be used for a double-sided earth bolt arrangement, according to various aspects of the invention.

### DETAILED DESCRIPTION

Disclosed herein are systems, methods, devices, and/or vehicles for implementing a double-sided earth bolt arrangement with one or more anti-rotation features. Aspects and/or embodiments are directed to providing a common connection point for at least two different wire terminals while also providing anti-rotation for both of the wire terminals. The double-sided earth bolt arrangement allows for grounding of electrical wiring to a vehicle ground structure in a safe and space efficient way while also allowing cost-effective model life management.

The double-sided earth bolt arrangement can replace current earth bolt designs with a new bolt that includes threaded shafts extending in opposite directions from a central head portion, allowing for double stacking of terminals, one underneath the head portion (sandwiched to body shell), and a second terminal above the head portion of the bolt fastened by a nut onto the upper threaded shaft. The double-sided earth bolt arrangement can include an anti-rotation structure for each of the first terminal and the second terminal to maintain proper orientation of the terminals and/or to prevent twisting of wiring during installation and/or during operation of the vehicle.

Aspects of the double-sided earth bolt arrangement combine the grounding capacity of two earth points on the body into one. This allows for less space on the body to be used as well as no need for hole punching or nut welding. A benefit is that during model life management the double-sided earth bolt can add capacity to already existing harness earth points without requiring either body modifications, or body holes/nuts to be required even when not used at initial design line-off (safeguard for future design changes).

As used herein, the terms “earth” and “ground” are used interchangeably. In a vehicle, the metal frame is generally designated as the reference point for the electrical system; this is ground in this case.

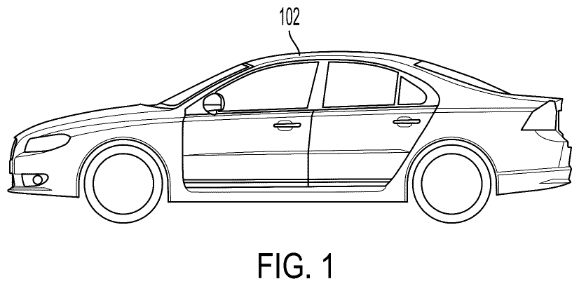

FIG. 1 is a side view of a vehicle 102 having one or more ground structures in accordance with various aspects. The ground structure can be part of the vehicle frame or can be any other suitable ground structure on the vehicle whereby electronics on-board the vehicle can be connected. A vehicle's ground can be a conductive path that provides a path for the battery's current to flow. While described herein with respect to a ground, aspects of the present disclosure can be utilized in connection with any suitable connection whereby multiple terminals are connected to a common point. The vehicle 102 may be a self-propelled wheeled conveyance, such as a car, a sport utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of electric/hybrid vehicle. Other examples of vehicles include bicycles, trains, planes, or boats, and any other form of conveyance that is capable of transportation. The vehicle 102 may be semi-autonomous or autonomous.

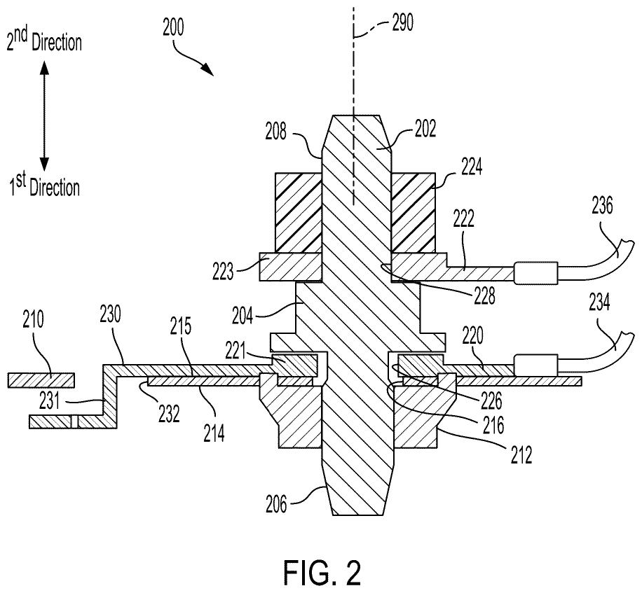

FIG. 2 is a schematic view of a double-sided earth bolt arrangement 200 (“arrangement 200”) in accordance with various aspects. Arrangement 200 can include a double-sided bolt 202. The double-sided bolt 202 includes a head portion 204, a first threaded rod 206 extending from the head portion 204 in a first direction, and a second threaded rod 208 extending from the head portion 204 in a second direction, opposite the first direction. The double-sided bolt 202 (i.e., the head portion 204, the first threaded rod 206, and the second threaded rod 208) can be formed as a single, monolithic piece. The double-sided bolt 202 can be made of a conductive material (e.g., metal). The first threaded rod 206 can be coaxial with the second threaded rod 208. The first threaded rod 206 can be coaxial with the head portion 204. The double-sided bolt 202 is configured to be mounted to a ground structure 210 whereby the first threaded rod 206 is threadingly coupled to the ground structure 210.

In various aspects, a threaded fastener 212 (e.g., a nut fastener) is connected to a back surface 214 of the ground structure 210. The ground structure 210 can include a first aperture 216. The threaded fastener 212 can be coupled to the back surface 214 at the first aperture 216 so that the first threaded rod 206 can be moved through the first aperture 216 and threadingly coupled to the threaded fastener 212. In various aspects, the threaded fastener 212 is joined to the back surface 214 of the ground structure 210 via a metal joining process (e.g., weld, solder, or braze). In this regard, the threaded fastener 212 can be a weld nut. In this manner, the ground structure 210 can include a threaded aperture (i.e., the threaded aperture of the threaded fastener 212).

Arrangement 200 can further include a first earth terminal 220 configured to be installed around the first threaded rod 206 between the head portion 204 and the ground structure 210. The first threaded rod 206 can be tightened with respect to the ground structure 210 and the threaded fastener 212 to compress the first earth terminal 220 between the head portion 204 and the front surface 215 of the ground structure 210. The first earth terminal 220 can include a first attachment portion 221 whereby the first earth terminal 220 is coupled to the first threaded rod 206. The first threaded rod 206 can extend through an aperture 226 disposed in the first attachment portion 221 of the first earth terminal 220. The first earth terminal 220 can include a first lead 234 (e.g., one or more conductive wires) whereby one or more electronic components are coupled to the ground structure 210.

Arrangement 200 can further include a second earth terminal 222 configured to be installed around the second threaded rod 208 and over the head portion 204. A threaded fastener 224 (e.g., a nut fastener) can be threaded to the second threaded rod 208 to secure the second earth terminal 222 to the double-sided bolt 202. The threaded fastener 224 can be tightened to compress the second earth terminal 222 between the threaded fastener 224 and the head portion 204. The second earth terminal 222 can include a second attachment portion 223 whereby the second earth terminal 222 is coupled to the second threaded rod 208. The second threaded rod 208 can extend through an aperture 228 disposed in the second attachment portion 223 of the second earth terminal 222. The second earth terminal 222 can include a second lead 236 (e.g., one or more conductive wires) whereby one or more electronic components are coupled to the ground structure 210.

In various aspects, the first earth terminal 220 includes an anti-rotation tab 230 (also referred to herein as a first tab) that extends through a second aperture 232 (also referred to herein as an anti-rotation aperture) disposed in the ground structure 210. The second aperture 232 extends through the ground structure 210 from the front surface 215 to the back surface 214. The anti-rotation tab 230 can mechanically block the first earth terminal 220 from rotating about the central axis 290 of the double-sided bolt 202. A portion 231 of the anti-rotation tab 230 can extend along the first direction through the second aperture 232 disposed in the ground structure 210. The first earth terminal 220 and the second earth terminal 222 can be installed on the same side of the ground structure 210.

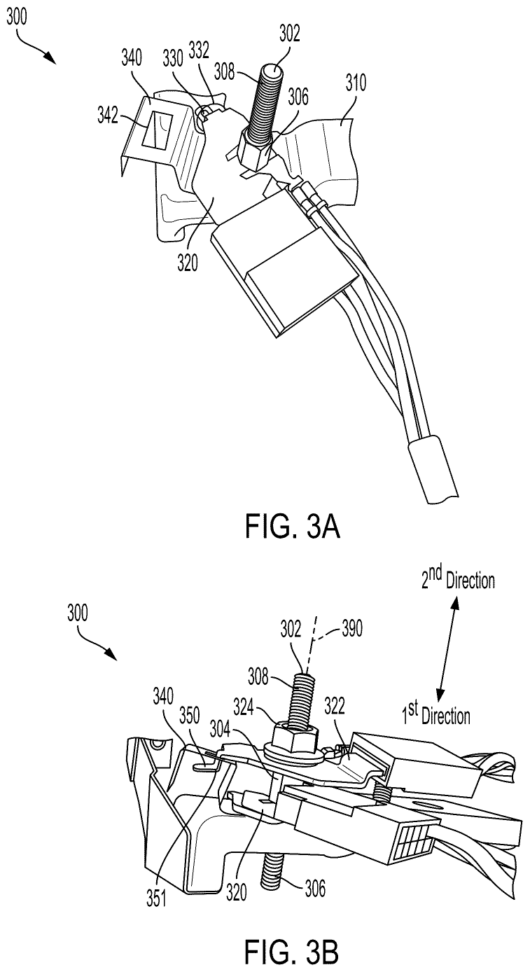

FIG. 3A is a perspective view of an example double-sided earth bolt arrangement 300 including an anti-rotation structure installed around the first threaded rod of the double-sided bolt 302 between the head portion 304 and the ground structure 310. FIG. 3A shows the arrangement 300 after the first earth terminal 320 has been installed and before the second earth terminal 322 (see FIG. 3B) has been installed. The anti-rotation structure 340 is configured to be compressed between the head portion 304 and the ground structure 310. The anti-rotation structure 340 includes an anti-rotation aperture 342 configured to receive a second tab 350 of the second earth terminal 322 (see FIG. 3B).

FIG. 3B is a perspective view of the double-sided earth bolt arrangement 300 of FIG. 3A with the second earth terminal 322 in the installed position. A threaded fastener 324 (e.g., a nut fastener) can be threaded to the second threaded rod 308 to secure the second earth terminal 322 to the double-sided bolt 302. The second earth terminal 322 includes a second tab 350 that is placed into the anti-rotation aperture 342 of the anti-rotation structure 340. A portion 351 of the second tab 350 can extend along the first direction in the installed position. The anti-rotation aperture 342 of the anti-rotation structure 340 can be offset (along the central axis 390) from the anti-rotation aperture 332 disposed in the ground structure 310. The anti-rotation aperture 342 of the anti-rotation structure 340 can be raised above the ground structure 310.

FIG. 3C is a top view of the double-sided earth bolt arrangement 300 of FIG. 3B in accordance with various aspects. FIG. 3D and FIG. 3E are section views of the double-sided earth bolt arrangement 300 of FIG. 3C taken along lines A-A and B-B, respectively. In various aspects, the first earth terminal 320 can be sandwiched between the head portion 304 and the anti-rotation structure 340. The threaded fastener 312 and the anti-rotation structure 340 can be located on opposite sides of the ground structure 310.

With combined reference to FIG. 3A through FIG. 3E, a method for grounding electrical wiring can include coupling the double-sided bolt 302 to the ground structure 310, for example by threading the first threaded rod 306 into the threaded fastener 312. The method can further include coupling the first earth terminal 320 around the first threaded rod 306 between the head portion 304 and the ground structure 310. The first threaded rod 306 can be placed through an aperture in the first earth terminal 320 before the first threaded rod 306 is tightened to the ground structure 310. The first tab 330 of the first earth terminal 320 can be positioned in the first anti-rotation aperture 332 disposed in the ground structure 310. The double-sided bolt 302 can be tightened to the ground structure 310 using the head portion 304. In response to tightening the double-sided bolt 302, the first earth terminal 320 can be compressed between the head portion 304 and the ground structure 310.

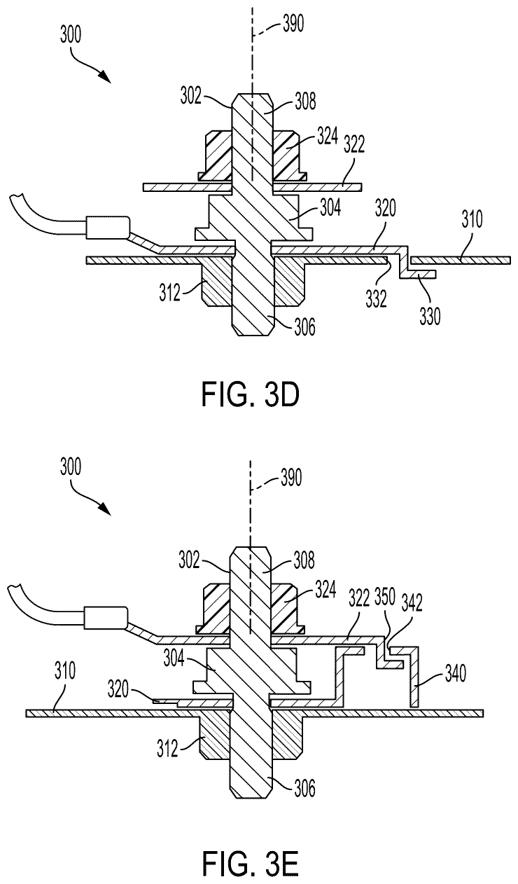

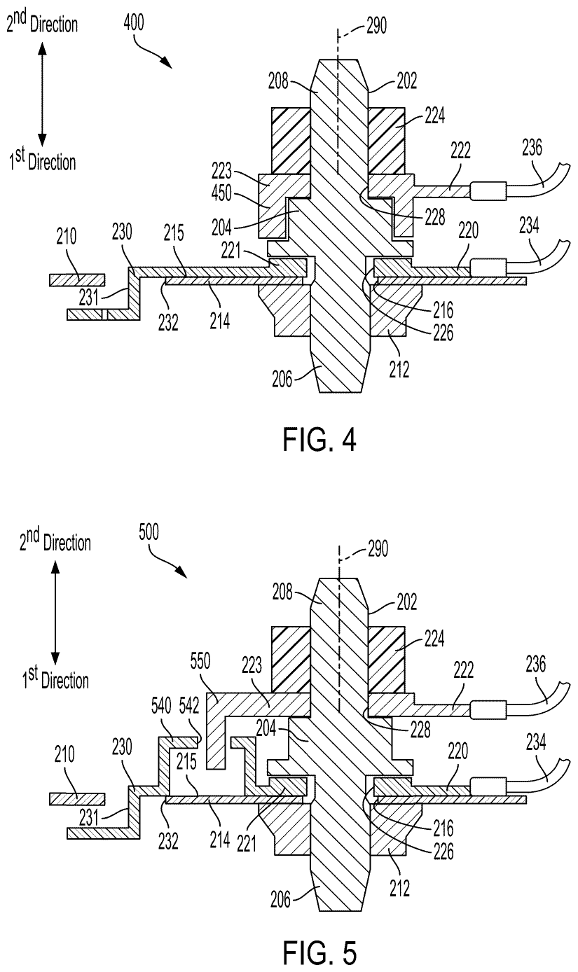

The method can further include coupling the second earth terminal 322 around the second threaded rod 308 and over the head portion 304. The second tab 350 of the second earth terminal 322 can be position in a second anti-rotation aperture (e.g., the anti-rotation aperture 342 of FIG. 3E, the anti-rotation aperture 542 of FIG. 5, or the anti-rotation aperture 642 of FIG. 6) that is fixed with respect to the ground structure 310. The threaded fastener 324 can be tightened over the second earth terminal 322 to the second threaded rod 308. In response to tightening the threaded fastener 324 to the second threaded rod 308, the second earth terminal 322 can be compressed between the head portion 304 and the threaded fastener 324.

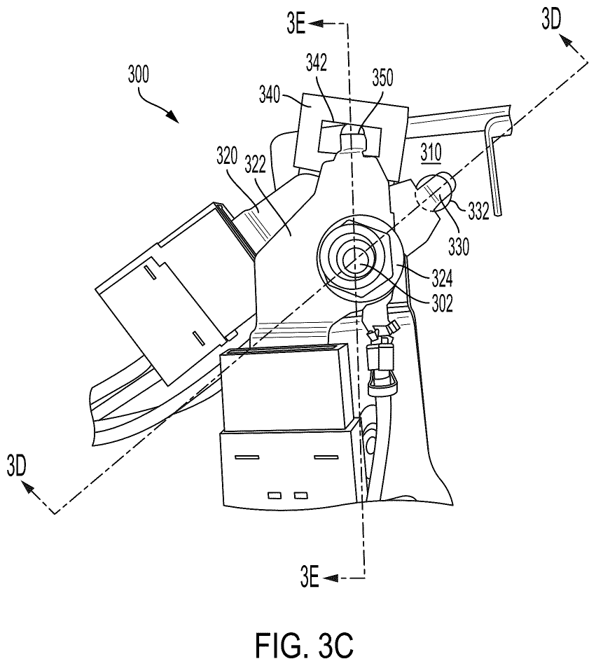

FIG. 4 is a schematic view of a double-sided earth bolt arrangement 400 in accordance with various aspects. With respect to FIG. 4, elements with like element numbering, as depicted in FIG. 2, are intended to be the same and will not necessarily be repeated for the sake of clarity. The double-sided earth bolt arrangement 400 can be similar to the double-sided earth bolt arrangement 200 of FIG. 2 except that the second earth terminal 222 further includes a tab or a flange 450 that engages (i.e., contacts) a side surface of the head portion 204 to prevent rotation of the second earth terminal 222 with respect to the head portion 204. In various aspects, the head portion 204 is in that shape of a hex head. Stated differently the head portion 204 can have a hexagonal shape. The geometry of the tab or flange 450 can be complementary to the geometry of the head portion 204. The tab or flange 450 can extend around a perimeter of the head portion 204. The second earth terminal 222 can lock onto the head portion 204 of the double-sided bolt 202 via the tab or flange 450. Using the tab or flange 450 as an anti-rotation feature can eliminate the need for a separate anti-rotation structure (e.g., the anti-rotation structure 340 of FIG. 3A through FIG. 3E).

FIG. 5 is a schematic view of a double-sided earth bolt arrangement 500 in accordance with various aspects. With respect to FIG. 5, elements with like element numbering, as depicted in FIG. 2, are intended to be the same and will not necessarily be repeated for the sake of clarity. The double-sided earth bolt arrangement 500 can be similar to the double-sided earth bolt arrangement 200 of FIG. 2 except that the second earth terminal 222 further includes a tab 550 that is configured to engage (i.e., contact) an anti-rotation structure 540 of the first earth terminal 220 to prevent rotation of the second earth terminal 222 with respect to the first earth terminal 220. In various aspects, the first earth terminal 220 can include an anti-rotation structure 540 extending in the second direction from the first attachment portion 221 whereby the second earth terminal 222 is coupled to the first earth terminal 220. The anti-rotation structure 540 can be similar to the anti-rotation structure 340 of FIG. 3A through FIG. 3E, except that the anti-rotation structure 540 is monolithically formed with the first attachment portion 221 of the first earth terminal 220. The anti-rotation structure 540 can include an aperture 542 configured to receive the anti-rotation tab 550 of the second earth terminal 222. In this regard, the tab 350 can be configured to be received by the anti-rotation aperture 542 disposed in the first earth terminal 220. The anti-rotation tab 550 can extend in the first direction from the second attachment portion 223 into the aperture 542. In this manner, the second earth terminal 222 can lock onto the first earth terminal 220 via the tab 550.

FIG. 6 is a schematic view of a double-sided earth bolt arrangement 600 in accordance with various aspects. With respect to FIG. 6, elements with like element numbering, as depicted in FIG. 3E, are intended to be the same and will not necessarily be repeated for the sake of clarity. The double-sided earth bolt arrangement 600 can be similar to the double-sided earth bolt arrangement 300 of FIG. 3E except that the anti-rotation structure 640 is extends from the ground structure 310 independent of the double-sided bolt 302 instead of being sandwiched between the double-sided bolt 302 and the ground structure 310. The anti-rotation structure 640 can be monolithically formed with the ground structure 310. The anti-rotation structure 640 can be coupled to the ground structure 310 using a metal joining process (e.g., weld, solder, or braze). In this regard, the tab 350 can be configured to be received by the anti-rotation aperture 642 disposed in the in the ground structure 310.

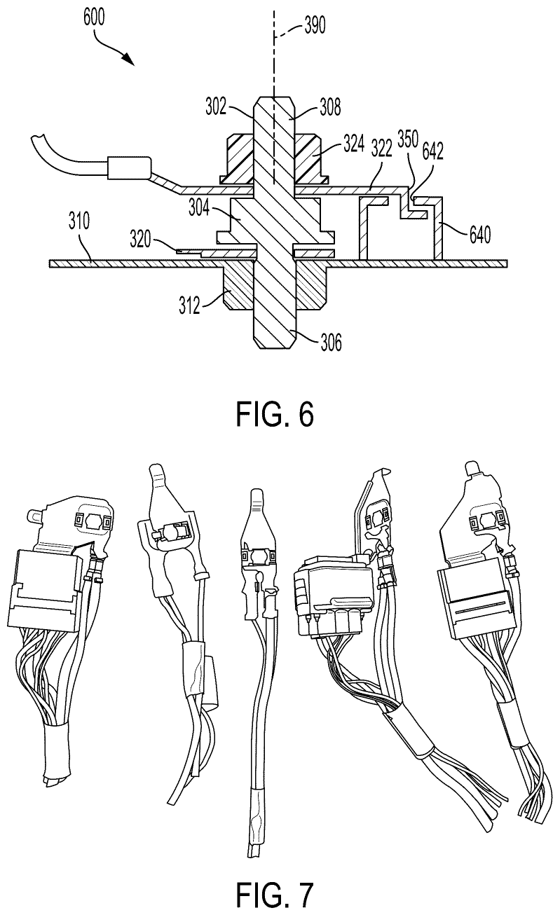

FIG. 7 is a schematic view of various types of earth terminals that can be used for the first earth terminal 220 and/or the second earth terminal 222 described herein. A double-sided earth bolt arrangement is not particularly limited by the type or design of the earth terminals.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A double-sided earth bolt arrangement, comprising:
a double-sided bolt including a head portion, a first threaded rod extending from the head portion in a first direction, and a second threaded rod extending from the head portion in a second direction, opposite the first direction, the double-sided bolt is configured to be mounted to a ground structure whereby the first threaded rod is threadingly coupled to the ground structure;
a first earth terminal configured to be installed around the first threaded rod between the head portion and the ground structure; and
a second earth terminal configured to be installed around the second threaded rod and over the head portion.

2. The double-sided earth bolt arrangement of claim 1, wherein the first earth terminal includes a first attachment portion whereby the first earth terminal is coupled to the first threaded rod and a first tab extending from the first attachment portion, the first tab is configured to extend along the first direction to be received by an anti-rotation aperture disposed in the ground structure.

3. The double-sided earth bolt arrangement of claim 1, wherein the second earth terminal includes a second attachment portion whereby the second earth terminal is coupled to the second threaded rod and a second tab extending from the second attachment portion, the second tab is configured to extend along the first direction in an installed position.

4. The double-sided earth bolt arrangement of claim 3, wherein the second tab is configured to engage a side surface of the head portion to prevent rotation of the second earth terminal.

5. The double-sided earth bolt arrangement of claim 3, wherein the second tab is configured to be received by at least one of:
a first anti-rotation aperture disposed in the first earth terminal; or
a second anti-rotation aperture disposed in the ground structure.

6. The double-sided earth bolt arrangement of claim 3, further comprising an anti-rotation structure configured to be installed around the first threaded rod between the head portion and the ground structure, the anti-rotation structure is configured to be compressed between the head portion and the ground structure, the anti-rotation structure includes an anti-rotation aperture configured to receive the second tab of the second earth terminal.

7. The double-sided earth bolt arrangement of claim 6, wherein the anti-rotation aperture is raised above the ground structure.

8. The double-sided earth bolt arrangement of claim 1, wherein the head portion has a hexagonal geometry, and the first threaded rod and the second threaded rod are in coaxial alignment.

9. A vehicle comprising:
a ground structure including a threaded aperture; and
a double-sided earth bolt arrangement, comprising:
a double-sided bolt including a head portion, a first threaded rod extending from the head portion in a first direction, and a second threaded rod extending from the head portion in a second direction, opposite the first direction, the double-sided bolt is configured to be mounted to the ground structure whereby the first threaded rod is threadingly coupled to the ground structure via the threaded aperture;
a first earth terminal configured to be installed around the first threaded rod between the head portion and the ground structure; and
a second earth terminal configured to be installed around the second threaded rod and over the head portion.

10. The vehicle of claim 9, wherein the first earth terminal includes a first attachment portion whereby the first earth terminal is coupled to the first threaded rod and a first tab extending from the first attachment portion, the first tab is configured to extend along the first direction to be received by an anti-rotation aperture disposed in the ground structure.

11. The vehicle of claim 9, wherein the second earth terminal includes a second attachment portion whereby the second earth terminal is coupled to the second threaded rod and a second tab extending from the second attachment portion, the second tab is configured to extend along the first direction in an installed position.

12. The vehicle of claim 11, wherein the second tab is configured to engage a side surface of the head portion to prevent rotation of the second earth terminal.

13. The vehicle of claim 11, wherein the second tab is configured to be received by at least one of:
a first anti-rotation aperture disposed in the first earth terminal; or
a second anti-rotation aperture disposed in the ground structure.

14. The vehicle of claim 11, further comprising an anti-rotation structure configured to be installed around the first threaded rod between the head portion and the ground structure, the anti-rotation structure is configured to be compressed between the head portion and the ground structure, the anti-rotation structure includes an anti-rotation aperture configured to receive the second tab of the second earth terminal.

15. The vehicle of claim 14, wherein the anti-rotation aperture is raised above the ground structure.

16. The vehicle of claim 9, wherein the head portion has a hexagonal geometry.

17. A method for grounding electrical wiring, comprising:
coupling a double-sided bolt to a ground structure, the double-sided bolt includes a head portion, a first threaded rod extending from the head portion in a first direction, and a second threaded rod extending from the head portion in a second direction, opposite the first direction, and coupling the double-sided bolt to the ground structure includes threadingly coupling the first threaded rod to the ground structure;
coupling a first earth terminal around the first threaded rod between the head portion and the ground structure;
coupling a second earth terminal around the second threaded rod and over the head portion.

18. The method of claim 17, further comprising:
tightening the double-sided bolt to the ground structure using the head portion; and
in response to tightening the double-sided bolt, compressing the first earth terminal between the head portion and the ground structure.

19. The method of claim 17, further comprising positioning a first tab of the first earth terminal in a first anti-rotation aperture disposed in the ground structure.

20. The method of claim 17, further comprising positioning a second tab of the second earth terminal in a second anti-rotation aperture that is fixed with respect to the ground structure.
